(19) United States
(12) Patent Application Publication
(10) Pub. No.: US 2012/0212819 A1
(43) Pub. Date: Aug. 23, 2012

(54) DIFFRACTIVE OPTICAL ELEMENT AND IMAGING APPARATUS USING THE SAME

(75) Inventors: Toshiaki TAKANO, Osaka (JP); Yoshiyuki SHIMIZU, Osaka (JP); Tetsuya SUZUKI, Osaka (JP); Koji FUJII, Osaka (JP)

(73) Assignee: PANASONIC CORPORATION, Osaka (JP)

(21) Appl. No.: 13/400,806

(22) Filed: Feb. 21, 2012

(30) Foreign Application Priority Data
Feb. 23, 2011 (JP) 2011-036761
Jan. 13, 2012 (JP) 2012-005378

(51) Int. Cl. G02B 27/42

(52) U.S. Cl. 359/558

(57) ABSTRACT

A diffractive optical element includes a diffractive surface. Raised portions and recessed portions are alternately arranged on the diffractive surface. A shape of the valley bottoms of the recessed portions varies according to regions of the diffractive surface.

### CROSS-REFERENCE TO RELATED APPLICATION

This application claims priority to Japanese Patent Application No. 2011-036761 filed on Feb. 23, 2011, and Japanese Patent Application No. 2012-005378 filed on Jan. 13, 2012, the disclosures of which including the specifications, the drawings, and the claims are hereby incorporated by reference in their entirety.

### TECHNICAL FIELD

The present disclosure relates to a diffractive optical element having at least one optical surface formed as a diffractive surface and an imaging apparatus including the diffractive optical element.

### BACKGROUND

A diffractive optical element in which at least one of optical surfaces is formed as a diffractive surface has been known (see, for example, Japanese Patent Publication No. H9-127321). For example, a diffractive optical element of Japanese Patent Publication No. H9-127321 is configured so that several optical members are stacked on each other and a boundary surface between the optical members is formed as a diffractive surface. The diffractive surface is formed by a diffractive grating having a serrated cross-sectional shape. Specifically, the diffractive surface at one of the optical members includes a plurality of raised portions each having a chevron shape, and as a whole has a shape in which raised and recessed portion are alternately repeated. The diffractive surface at the other of the optical members has an inverted shape relative to the shape of the diffractive surface at the one of the optical members.

### SUMMARY

In forming a diffractive optical element having the above-described diffractive surface, a molding technique such as press molding, etc. is used. However, in the conventional refractive optical element, cracks might occur at valley bottoms of the recessed portions. For example, the diffractive optical element is contracted in a cooling step in molding of the diffractive optical element. In this case, since the raised and recessed portions of the diffractive element are engaged with raised and recessed portions of a metal die, the raised portions of the diffractive optical element receive restriction from the metal die. As a result, cracks might occur at the valley bottoms of the recessed portions of the diffractive optical element. Even in other cases, cracks might occur at the valley bottoms of the recessed portions for various reasons.

In view of the foregoing, a technique disclosed therein has been devised to prevent or reduce cracks in a diffractive optical element.

A diffractive optical element disclosed herein is a diffractive optical element including a diffractive surface in which raised portions and recessed portions are alternately arranged on the diffractive surface and a shape of valley bottoms of the recessed portions varies according to regions of the diffractive surface. Each of the “valley bottoms” is a connection portion of two surfaces forming an associated one of the recessed portions, i.e., a corner portion.

Thus, in the diffractive optical element, a shape of valley bottoms of the recessed portions varies according to regions of the diffractive surface, so that the occurrence of cracks can be prevented or reduced.

### BRIEF DESCRIPTION OF THE DRAWINGS

FIG. 1 is a schematic cross-sectional view of a diffractive optical element according to a first embodiment.

FIG. 2 is an enlarged cross-sectional view of a recessed portion.

FIG. 3 is a cross-sectional view schematically illustrating respective steps for forming a diffractive optical element according to the first embodiment. FIG. A illustrates a state in which a glass material is set on a molding die, and FIG. B illustrates a state in which the glass material is pressed by the molding die.

FIG. 4 is a schematic cross-sectional view of a diffractive optical element according to a variation.

FIG. 5 is a view of a diffractive optical element according to another variation. FIG. A illustrates a schematic cross-sectional view of the diffractive optical element, and FIG. B illustrates an enlarged cross-sectional view of a recessed portion.

FIG. 6 is a schematic cross-sectional view of a diffractive optical element according to a second embodiment.

FIG. 7 is a schematic cross-sectional view of a diffractive optical element according to a third embodiment.

FIG. 8 is a cross-sectional view schematically illustrating respective steps for producing a diffractive optical element according to the second embodiment. FIG. A illustrates a state in which a resin material is set on a molding die, FIG. B illustrates a state in which the resin material is pressed by a first optical member and the molding die, and FIG. C illustrates a state in which a diffractive optical element is removed from the molding die.

FIG. 9 is a schematic cross-sectional view of a diffractive optical element according to a fourth embodiment.

FIG. 10 is a schematic cross-sectional view of an imaging apparatus according to a fifth embodiment.

### DETAILED DESCRIPTION

Example embodiments will be described in detail below with reference to the accompanying drawings.

### First Embodiment

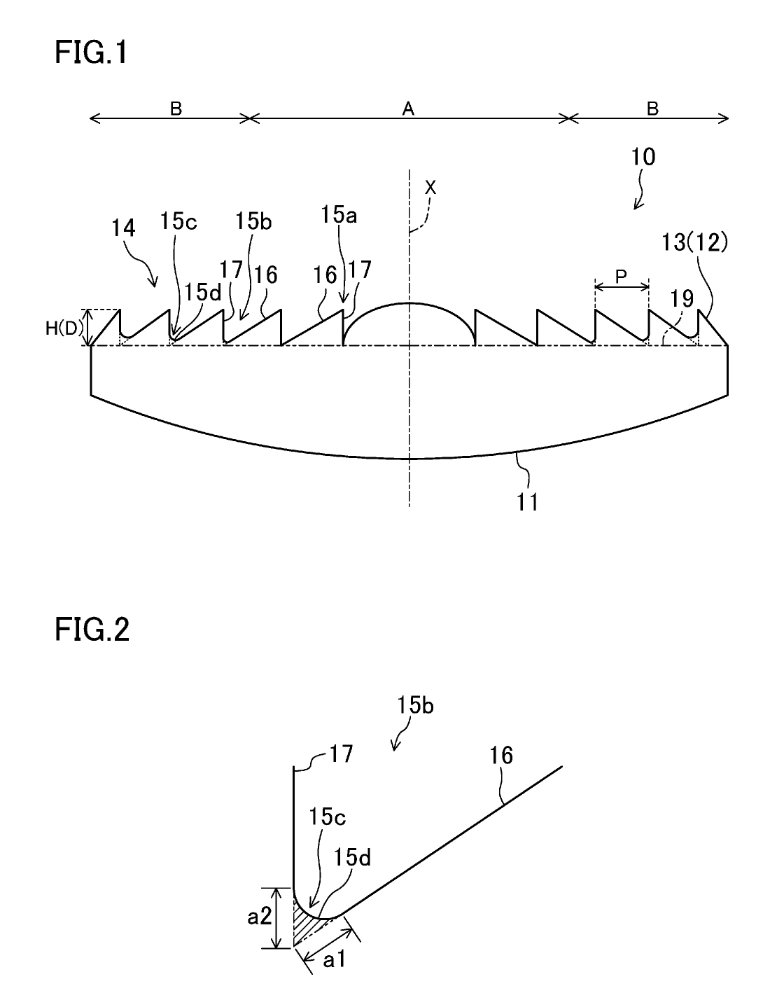

FIG. 1 is a schematic cross-sectional view of a diffractive optical element 10 according to this embodiment.

The diffractive optical element 10 is formed of an optical member which is optically transparent. The diffractive optical element 10 includes a first optical surface 11 and a second optical surface 12 which are opposed to each other. The second optical surface 12 is formed as a diffractive surface 13. That is, at least one optical surface (the second optical surface 12) of the diffractive optical element 10 is formed as the diffractive surface 13. The diffractive optical element 10 may be made of an optical material such as a glass material, or a resin material, etc. Note that the first optical surface 11 may be a spherical or an aspherical surface.

As the diffractive surface 13, a diffractive grating 14 is formed. The diffractive grating 14 includes a plurality of raised portions 15a and a plurality of recessed portions 15b. The raised portions 15a and the recessed portions 15b are formed on a base surface 19. The base surface 19 may be a flat surface. Each of the raised portions 15a extends in a circumferential direction around an optical axis X of the diffractive optical element 10. The plurality of raised portions 15a are regularly arranged in a concentric pattern around the optical axis X. As a result, a recessed portion 15b is formed between adjacent ones of the raised portions 15a. That is, each of the recessed portions 15b extends in the circumferential direction around the optical axis X. The plurality of recessed portions 15b are regularly arranged in a concentric pattern around the optical axis X.

A lateral cross section (a cross section perpendicular to a direction in which the raised portions 15a extend) of each of the raised portions 15a may have a substantially triangular shape. More specifically, each of the raised portions 15a may have a first surface 16 which is tilted relative to the optical axis X and has a diffraction function, and a second surface 17 rising from the base surface 19 and connected to the first surface 16. In each of the raised portions 15a, the first surface 16 is at the outer side in a radial direction around the optical axis X, and the second surface 17 is at the inner side in the radiation direction. In adjacent two of the raised portions 15a, the first surface 16 of one of the two raised portions 15a and the second surface 17 of the other of the two raised portions 15a form the recessed portion 15b. That is, it can be also described that the recessed portion 15b has the first surface 16 having the diffraction function and the second surface 17 connected to the first surface 16 and rising from the base surface 19.

FIG. 2 is an enlarged cross-sectional view of the recessed portion 15b. A valley bottom 15c of each of the recessed portions 15b is formed to have a chamfered shape. The term “chamfer” used herein means not only to form a surface at a ridge portion but also to form a surface at a valley line portion, i.e., to form a fillet or building to the valley line portion. The valley bottom 15c herein means a connection portion of the first surface 16 and the second surface 17 forming the recessed portion 15b. The valley bottom 15c corresponds to the lowest portion of the recessed portion 15b. That is, the connection portion of the first surface 16 and the second surface 17 forming the recessed portion 15b is formed by not a valley line but a surface 15d. In this embodiment, the surface 15d is a curved surface. In other words, each of the valley bottoms 15c has an R-chamfered (round chamfered) shape.

The first surface 16 is a tilted surface which is tilted relative to the optical axis X, and has the diffraction function. A tilt angle of the first surface 16 of each of the raised portions 15a is appropriately set so that the diffractive surface 13 as a whole can have the desired diffraction function.

The second surface 17 rises from the base surface 19 and is connected to a distal end (a farther end from the base surface 19) of the first surface 16. In this embodiment, the second surface 17 extends parallel to the optical axis X.

In this embodiment, the height (which will be also referred to as “lattice height”) H of the raised portions 15a is substantially uniform throughout the diffractive optical element 10. The height of the raised portions 15a herein means a distance from the base surface 19 to a top (a ridge portion) of each raised portion 15a in the optical axis X direction. The base surface 19 is defined by a plane passing through lowest potions of the recessed portions 15b when it is assumed that the valley bottoms 15c are not chamfered. That is, in each of the recessed portions 15b, an imaginary valley line obtained by imaginarily elongating the first surface 16 and the second surface 17 downward so that the first surface 16 and the second surface 17 meet each other is the “lowest portion of the recessed portion 15b.” The pitch P of the raised portions 15a is smaller in an outer region B of the diffractive optical element 10 located outside a central region A thereof including the optical axis X than in the central region A. For example, assuming that the diffractive surface 13 is divided into two regions in the radial direction, the central region A is one of the two regions which is located closer to the center of the diffractive surface 13, and the outer region B is the other of the regions which is located at an outer side of the diffractive surface 13. Specifically, the pitch P reduces as a distance from the optical axis X in the radial direction increases. The pitch P of the raised portions 15a herein means a distance between adjacent ones of the tops of the raised portions 15a in the radial direction around the optical axis X. For example, the lattice height H of the raised portions 15a is 5-20 μm. The pitch P of the raised portions 15a is 400-2000 μm in the central region A, and is 100-400 μ in the outer region B. These values can be appropriately set according to optical properties required for the diffractive optical element.

Note that the depth of the recessed portions 15b herein means a distance in the optical axis X direction extending from a plane passing through tops of the raised portions 15a to an imaginary valley line obtained by imaginarily elongating the first surface 16 and the second surface 17 downward so that the first surface 16 and the second surface 17 meet each other. In terms of the depth of the recessed portions 15b, the depth D of the recessed portions 15b is substantially uniform throughout the entire region of the diffractive optical element 10. The pitch of the recessed portions 15b used herein means a distance between the valley bottoms 15c in the radial direction around the optical axis X. In terms of the pitch of the recessed portions 15b, the pitch of the recessed portions 15b reduces as a distance from the optical axis X in the radial direction increases.

The shape of the valley bottoms 15c in the recessed portions 15b varies according to regions in the diffractive surface 13. Furthermore, the extent of chamfering of the valley bottoms 15c varies according to the regions in the diffractive surface 13. The “extent of chamfering” herein means the amount of a valley portion removed by the surface 15d resulting from chamfering, i.e., a chamfer dimension. The “extent of chamfering” can be represented, for example, by a value obtained by summing up, when two surfaces form a valley line, a dimension (a chamfer dimension) from the valley line to a cut-off point in one of the two surfaces and a dimension (a chamfer dimension) from the valley line to a cut-off point in the other one of the two surfaces. Referring to FIG. 2, the “extent of chamfering” can be presented by a1+a2. The larger the obtained sum is, the larger the “extent of chamfering” becomes. The “extent of chamfering” can be represented by the width of the surface 15d (i.e., the length of the surface 15d in a cross section thereof), and a greater width of the surface 15d results in a greater “extent of chamfering.” For example, when the valley bottom is R-chamfered (i.e., when the surface 15d is a curved surface), the “extent of chamfering” can be represented by the radius of curvature of the surface 15d formed by chamfering, and the larger the radius of curvature is, the “extent of chamfering” becomes. Note that the extent of a fillet or building can be considered as the “extent of chamfering,” and in such a case, the “extent of chamfering” means the amount of a building portion (a hatched portion) which fills a corresponding valley including the valley line.

Specifically, the extent of chamfering of the valley bottoms 15c in the central region A is different from that in the outer region B. For example, the extent of chamfering of the valley bottoms 15c is small in the central region A, while the extent of chamfering of the valley bottoms 15c is large in the outer region B. More specifically, the value obtained by summing up the chamfer dimensions in the valley bottoms 15c is small and the radius of curvature of the surface 15d is small in the central region A, while the value obtained by summing up the chamfer dimensions in the valley bottoms 15c is large and the radius of curvature of the surface 15d is large in the outer region B.

More specifically, the extent of chamfering of the valley bottoms 15c increases, as a distance outward from the center in the radial direction increases (i.e., from the inner side to the outer side in the radial direction). Specifically, the value obtained by summing up the chamfer dimensions in the valley bottoms 15c increases from the inner side to the outer side in the radial direction, and the radius of curvature of the surfaces 15d of the valley bottoms 15c increases from the inner side to the outer side in the radial direction.

Note that not all of the valley bottoms 15c have to have a chamfered shape, and some of the valley bottoms 15c may have an acute shape which does not have the surface 15d.

With the above-described configuration, cracks at the diffractive grating 14 can be prevented or reduced. If each of the valley bottoms 15c of the recessed portions 15b is formed to have an acute shape with an edge when viewing a lateral cross section thereof, stress is likely concentrated at the valley bottoms 15c when an external force acts on the raised portions 15a. As a result, cracks might occur at the valley bottoms 15c. As opposed to such a case, concentration of stress in the valley bottoms 15c can be reduced by forming the valley bottoms 15c so that each of the valley bottoms 15c has a chamfered shape. As a result, cracks at the valley bottoms 15c can be prevented or reduced. The valley bottoms 15c have different fragilities according to regions in the diffractive surface 13. In this embodiment, a shape of the valley bottoms 15c varies according to regions in the diffractive surface 13. For example, in a cooling step of press molding, cracks likely occur at the valley bottoms 15c located in the outer region in the radial direction. Specifically, in a cooling step after press molding, the diffractive optical element 10 is contracted. At this time, since the raised portions 15a of the diffractive optical element 10 are engaged with raised portions of the upper die 21, movement of the raised portions 15a in the radial direction is restricted by the raised portions of the upper die 21. Therefore, a force acts on the raised portions 15a toward an outer side of the diffractive optical element 10 in the radial direction. In this case, stress is likely concentrated at the valley bottoms 15c of the recessed portions 15b, and thus, cracks likely occur at these portions. As opposed to such a case, in this embodiment, the extent of chamfering of the valley bottoms 15c is larger in the outer region B than that in the central region A. Thus, concentration of stress in the valley bottoms 15c can be reduced more in the outer region B in which cracks likely occur inherently. Thus, cracks at the diffractive optical element 10 can be prevented or reduced.

On the other hand, when the valley bottoms 15c are formed to have a chamfered shape, the area of the first surface 16 having the diffraction function is reduced. Therefore, in the region in which cracks hardly occurs, the extent of chamfering of the valley bottoms 15c is small (including a state in which the valley bottoms 15c are not chamfered). Thus, reduction in diffraction function resulting from forming the chamfered shape can be prevented or reduced.

For example, in a diffractive lens having a diameter of 30 mm or more, the valley bottoms 15c may be formed so that the radius of curvature of the valley bottoms 15c located in a region within a radius of less than 5 mm from the optical axis is less than 0.5 μm (including a state in which the valley bottoms 15c are not chamfered), the radius of curvature of the valley bottoms 15c located in a region within a radius of 5 nm or more and less than 10 mm from the optical axis is 4 μm, and the radius of curvature of the valley bottoms 15c located in a region within a radius of 10 mm or more from the optical axis is 8 μm. Thus, a loss of diffraction efficiency can be reduced to an essential minimum, while preventing or reducing cracks at the diffractive grating 14.

[Production Method]

Next, a method for producing a diffractive optical element 10 according to this embodiment will be described.

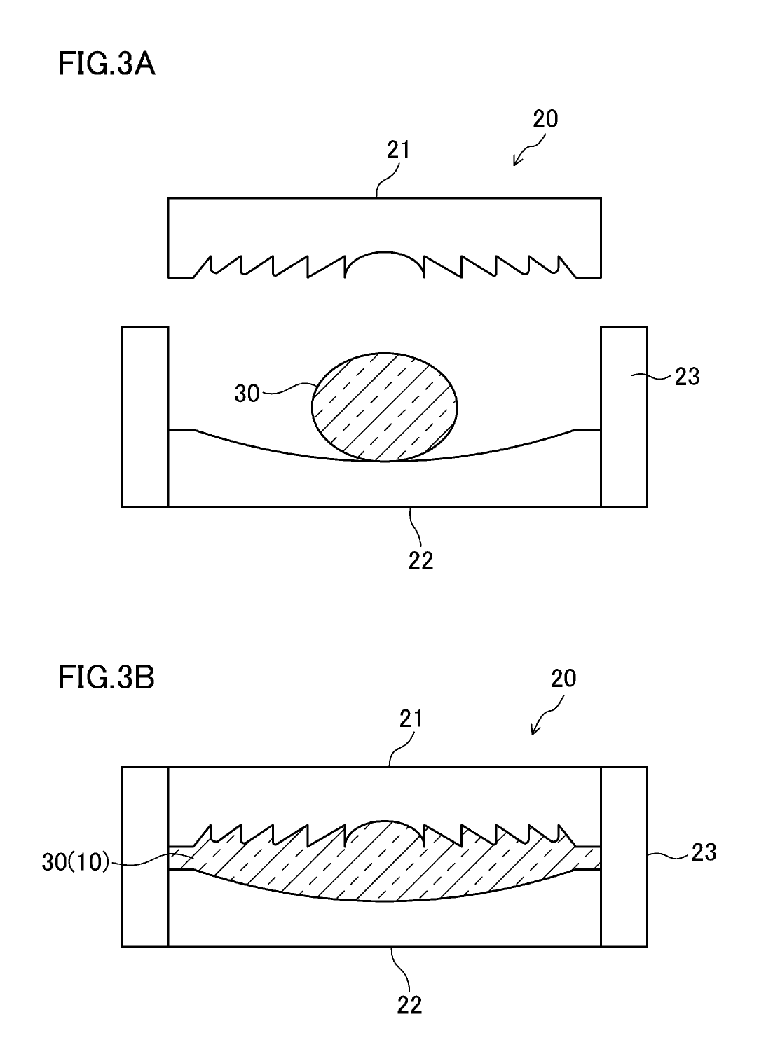

First, as shown in FIG. 3A, a molding die 20 (an upper die 21, a lower die 22, and a body die 23) is prepared. An inverted shape relative to the shape of the diffractive surface 13 is formed in a molding surface of the upper die 21. In this case, a plurality of raised portions are formed in a molding surface of the upper die 21. Tips of the raised portions are chamfered to correspond to the valley bottoms 15c of the diffractive surface 13. A molding surface of the lower die 22 is a spherical surface or an aspherical surface. A glass material 30 is placed on the molding surface of the lower die 22. Next, as shown in FIG. 3B, the upper die 21 is moved down toward the lower die 22 along the body die 23, thereby pressing the glass material 30. Process conditions such as a molding temperature and a molding time, etc. are set appropriately.

After pressing is completed, the upper die 21 is moved upward to remove the glass material 30 from the lower die 22. The diffractive optical element 10 is obtained by cooling down the glass material 30 for a predetermined time.

[Advantages]

In the diffractive optical element 10 of this embodiment, the valley bottom 15c of the recessed portion 15b is formed by the first surface 16 and the second surface 17 and has a chamfered shape (i.e., not a valley line but a surface is formed), and thus, cracks at the valley bottoms 15c can be prevented or reduced. In addition, the valley bottoms 15c are formed so that the shape of the valley bottoms 15c varies according to regions in the diffractive surface 13. Thus, cracks can be effectively prevented or reduced by forming the valley bottoms 15c with a large extent of chamfering in a region in which cracks likely occur, and the loss of diffraction efficiency can be reduced to a minimum by forming the valley bottoms 15c with a small extent of chamfering (including a state in which the valley bottoms 15c are not chamfered) in a region in which cracks hardly occur. That is, both of reduction in cracks and improvement of diffraction efficiency can be achieved.

The shape of the valley bottoms 15c of the recessed portions 15b in the central region A of the diffractive surface 13 is different from that in the outer region B located outside the central region A. How likely cracks occur at the valley bottoms 15c in the central region A is different from that in the outer region B, and therefore, using the above-described configuration, the valley bottoms 15c can be formed so that the shape thereof varies according to how likely cracks occur. For example, each of the valley bottoms 15c of the recessed portions 15b is formed to have a chamfered shape, and the extent of chamfering of the valley bottoms 15c in the outer region B is larger than that in the central region A. Specifically, the radius of curvature of the surfaces 15d of the valley bottoms 15c in the outer region B is larger than that of the surfaces 15d of the valley bottoms 15c in the central region A. The larger the extent of chamfering is, the less acute the valley bottoms 15c become, and thus, cracks at the valley bottoms 15c hardly occur. That is, using the above-described configuration, cracks at the valley bottoms 15c in the outer region B can be reduced more, as compared to the central region A of the diffractive surface 13, while the diffraction efficiency in the central portion A can be increased, as compared to the outer region B. In a cooling step of press molding, cracks likely occur at the valley bottoms 15c in the outer region B of the diffractive surface 13, and therefore, the above-described configuration is particularly effective. Also, the outer region B of the diffractive surface 13 more likely comes in contact with some other object, so that a large impact is applied to the raised portions 15a more likely, as compared to the central region A. In view of this, the above-described configuration is also particularly effective.

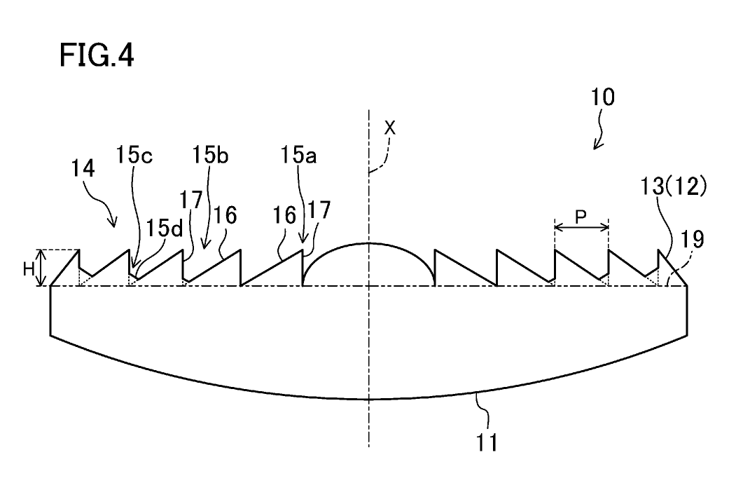

Note that, as a variation, as shown in FIG. 4, the chamfered shape of the valley bottoms 15c may be a shape in which the surface 15d is flat, i.e., a so-called C-chamfered shape. In this case, cracks at the valley bottoms 15c can be also prevented or reduced. For example, for a diffractive lens having a diameter of 30 mm or more, a width of a surface of each of the valley bottoms 15c (a length of a straight line in the lateral cross section) is preferably 1 μm or more, and more preferably 3-5 μm. Also, an angle of a surface formed by chamfering relative to the optical axis X is preferably 30-60 degrees, and more preferably 45 degrees.

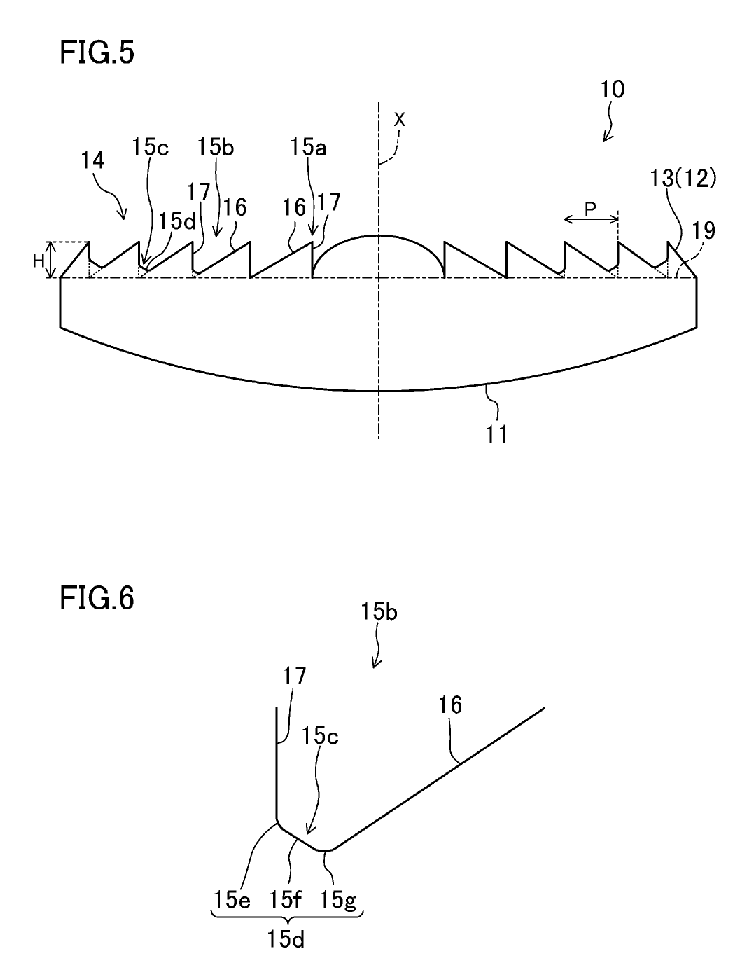

Furthermore, as another variation, as shown in FIGS. 5A and 5B, the chamfered shape of the valley bottoms 15c may be a shape formed by a curved surface 15e, a flat surface 15f, and a curved surface 15g (a shape formed by a straight line and curved lines connected to both ends of the straight line, when viewing a lateral cross section). That is, the chamfered shape of the valley bottoms 15c may be a shape formed by a combination of an R-chamfered shape, a C-chamfered shape, and an R-chamfered shape. Even in this case, cracks at the valley bottoms 15c can be also prevented or reduced.

### Second Embodiment

Next, a diffractive optical element 210 according to a second embodiment will be described with reference to the accompanying drawings. FIG. 6 is a schematic cross-sectional view of the diffractive optical element 210.

The diffractive optical element 210 of this embodiment is different from the diffractive optical element 10 of the first embodiment in that the height of the raised portions increases as a distance from the center outward in the radial direction of the diffractive optical element 210 increases. Therefore, the diffractive optical element 210 will be described below with focus on the difference from the diffractive optical element 10 of the first embodiment. Each configuration having similar function and shape to those in the first embodiment is given the same reference character, and the description thereof might be omitted.

A diffractive surface 213 of the diffractive optical element 210 includes a base surface 19 and a diffractive grating 214 formed on the base surface 19. The diffractive grating 214 has a plurality of raised portions 15a and a plurality of recessed portions 15b which are alternately arranged. The height H of the raised portions 15a is higher in an outer region B than in a central region A. Similarly, the depth D of the recessed portions 15b is larger in the outer region B than in the central region A. More specifically, the depth D of the recessed portions 15b increases as a distance from the center of the diffractive surface 13 toward the outer edge thereof in the radial direction increases. The extent of chamfering of the valley bottoms 15c of the recessed portions 15b in the outer region B is larger than the extent of chamfering of the valley bottoms 15c of the recessed portions 15b in the central region A. That is, the larger the depth of the recessed portions 15b is, the larger the extent of the chamfering of the valley bottoms 15c becomes.

The strength of the raised portions 15a reduces as the height of the raised portions 15a increases. Therefore, cracks likely occur at the valley bottoms 15c during press molding, etc. When the height of the raised portions 15a is large, the depth of the recessed portions 15b adjacent thereto is large. That is, in view of the depth of the recessed portions 15b, the larger the depth of recessed portions 15b is, the more likely cracks occur at the valley bottoms 15c. However, as opposed to the above, in this embodiment, the extent of the valley bottoms 15c of the recessed portions 15b having a larger depth is large. Thus, cracks at the valley bottoms 15c can be effectively prevented or reduced.

Therefore, according to this embodiment, the depth of the recessed portions 15b varies according to regions of the diffractive surface 13, and the shape of the valley bottoms 15c in a region in which the depth of the recessed portions 15b is large is different from that in a region in which the depth of the recessed portions 15b is small. Specifically, the valley bottoms 15c of the recessed portions 15b are formed so that each of the valley bottoms 15c has a chamfered shape, and the extent of chamfering of the valley bottoms 15c in the region in which the depth of the recessed portions 15b is large is larger than that in the region in which the depth of the recessed portions 15b is small. For example, the radius of curvature of the surface 15d of the valley bottoms 15c in the region in which the depth of the recessed portions 15b is larger than that of the surface 15d of the valley bottoms 15c in the region in which the depth of the recessed portions 15b is small. Thus, cracks can be effectively prevented or reduced at the recessed portions 15b which has a large depth and at which cracks likely occur inherently, and the loss of diffraction efficiency can be prevented or reduced at the recessed portions 15b which has a small depth and at which cracks hardly occur.

### Third Embodiment

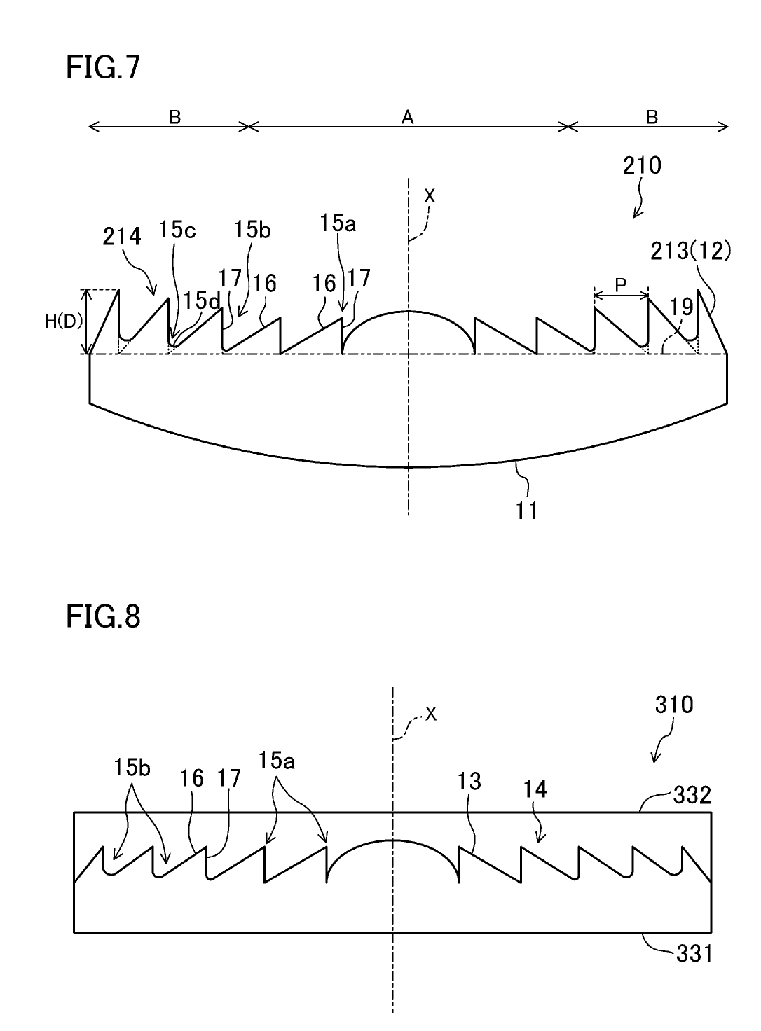

Next, a diffractive optical element 310 according to a third embodiment will be described with reference to the accompanying drawings. FIG. 7 is a schematic cross-sectional view of the diffractive optical element 310.

The diffractive optical element 310 of this embodiment is different from the diffractive optical element 10 of the first embodiment in that a plurality of optical members are stacked. Therefore, the diffractive optical element 310 will be described below with focus on the difference from the diffractive optical element 10 of the first embodiment. Each configuration having similar function and shape to those in the first embodiment is given the same reference character, and the description thereof might be omitted.

As shown in FIG. 7, the diffractive optical element 310 is a close-contact multilayer diffractive optical element in which a first optical member 331 and a second optical member 332 each of which is optically transparent are stacked.

The first optical member 331 and the second optical member 332 are jointed to each other. A boundary surface of the first optical member 331 and the second optical member 332 is formed as the diffractive surface 13. Since the optical power of the diffractive surface 13 has the dependence on wavelength, the diffractive surface 13 gives substantially the same phase difference to lights having different wavelengths to diffract the lights having different wavelengths at different diffraction angles.

In this embodiment, the first optical member 331 is made of a glass material, and the second optical member 332 is made of a resin material. For example, as the resin material, an ultraviolet curable resin or a thermally curable resin can be used.

[Production Method]

A method for producing the diffractive optical element 310 will be described. FIGS. 8A-8C are cross-sectional views illustrating respective steps for producing a diffractive optical element according to the third embodiment. FIG. 8A illustrates a state in which a resin material is set on a molding die, FIG. 8B illustrates a state in which the resin material is pressed by a first optical member and the molding die, and FIG. 8C illustrates a state in which a diffractive optical element is removed from the molding die.

First, the first optical member 331 is prepared. The first optical member 331 can be produced in the same manner as in the first embodiment.

Subsequently, as shown in FIG. 8A, a lower die 324 is prepared. The lower die 324 has a shape corresponding to a shape of a surface of the second optical member 332 which is opposed to the diffractive surface 13. Then, an ultraviolet curable resin material 340 is placed on the lower die 324. Thereafter, the first optical member 331 is moved toward the lower die 324 with the diffractive surface 13 facing toward the lower die 324.

Then, as shown in FIG. 8B, the resin material 340 is pressed by the first optical member 331 and the lower die 324 to deform the resin material 340 into a shape corresponding to the shapes of the first optical member 331 and the lower die 324. Thereafter, the resin material 340 is irradiated with ultraviolet radiation 350. When the resin material 340 is irradiated with the ultraviolet radiation 350 for a predetermined time, the resin material 340 is hardened, and thus, the second optical member 332 is formed.

Thereafter, as shown in FIG. 8C, the first optical member 331 and the second optical member 332 are removed from the lower die 324, and thus, the diffractive optical element 310 including the first optical member 331 and the second optical member 332 integrated as one can be obtained.

### Fourth Embodiment

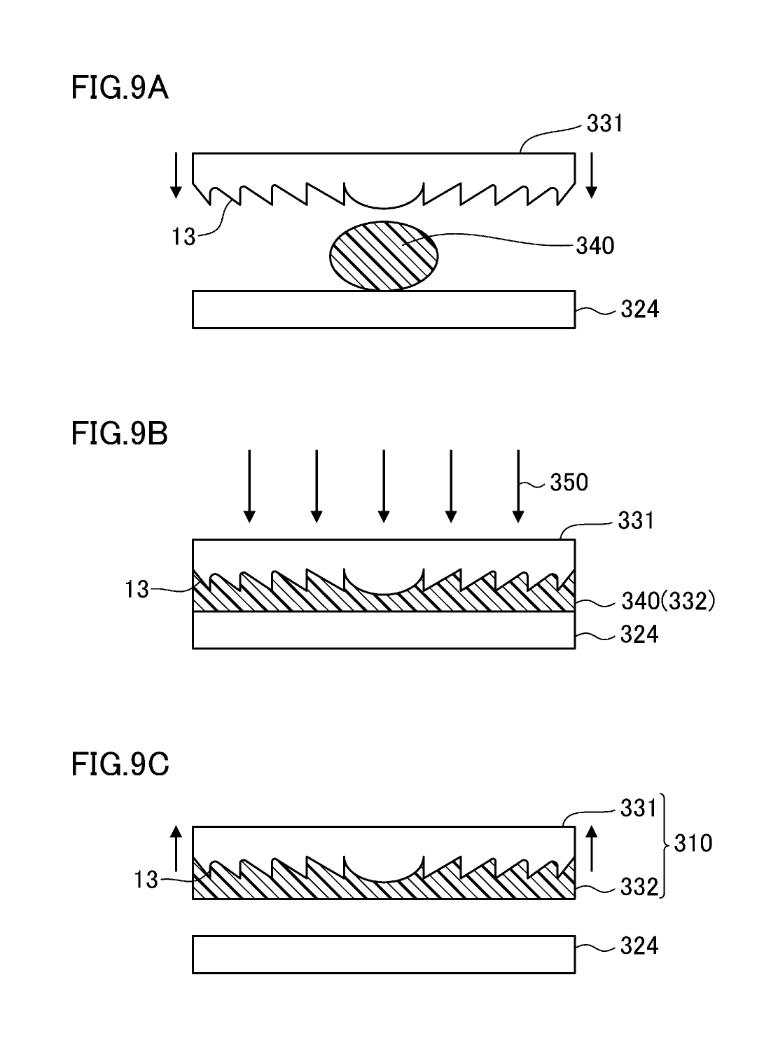

Next, a diffractive optical element 410 according to a fourth embodiment will be described with reference to the accompanying drawings. FIG. 9 is a schematic cross-sectional view of the diffractive optical element 410.

In the diffractive optical element 410, a third optical member 433 is stacked on the second optical member 332 of the diffractive optical element 310 of the third embodiment. The third optical member 433 is made of a glass material or a resin material.

### Fifth Embodiment

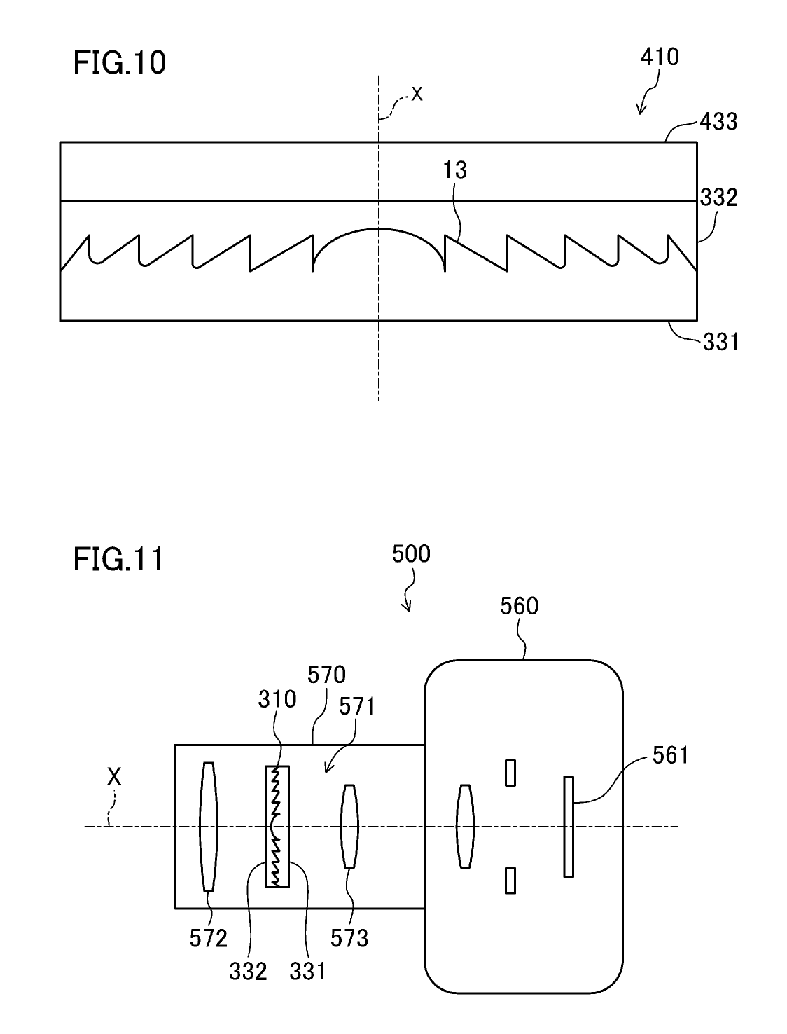

Next, a camera 500 according to a fifth embodiment will be described with reference to the accompanying drawings. FIG. 10 is a schematic view of the camera 500.

The camera 500 includes a camera body 560, and an interchangeable lens 570 attached to the camera body 560. The camera 500 serves as an imaging apparatus.

The camera body 560 includes an imaging device 561.

The interchangeable lens 570 is configured to be removable from the camera body 560. The interchangeable lens 570 is, for example, a telephoto zoom lens. The interchangeable lens 570 has an imaging optical system 571 for focusing a light bundle on the imaging device 561 of the camera body 560. The imaging optical system 571 includes the diffractive optical element 310 and refracting lenses 572 and 573. The diffractive optical element 310 functions as a lens element. The interchangeable lens 570 serves as an optical apparatus.

### Other Embodiments

The above-described embodiments may have the following configurations.

The configuration of the diffractive grating 14 described in the above-described embodiments is merely one example, and a diffractive grating according to the present disclosure is not limited to the above-described configuration. For example, each of the raised portions 15a is formed so that a surface thereof at the outer side in the radial direction is the first surface 16 and a surface thereof at the inner side in the radial direction is the second surface 17. However, the raised portions 15a are not limited thereto. That is, each of the raised portions 15a may be configured so that a surface thereof at the outer side in the radial direction is the second surface 17, and a surface thereof at the inner side in the radial direction is the first surface 16.

Also, the lattice height and the pitch of the raised portions 15a, and the depth and the pitch of the recessed portions 15b are not limited to those described in the above-described embodiments. For example, the lattice height of the raised portions 15a may be larger in the central region A than in the outer region B. Similarly, the depth of the recessed portions 15b may be larger in the central region A than in the outer region B. In that case, the extent of the chamfering of the valley bottoms 15c is larger in the central region A than in the outer region B. Also, each of the pitch of the raised portions 15a and the pitch of the recessed portions 15b may be smaller in the central region A than in the outer region B, and alternatively, may be uniform throughout the entire region of the diffractive surface. In the above-described embodiments, the pitch gradually varies according to a location in the radial direction. However, the diffractive surface may be divided into a plurality of regions, and the pitch may be set to be uniform in the same region and different between different regions. Similarly, the lattice height may be set in this manner.

In the above-described embodiments, the second surface 17 extends parallel to the optical axis X. However, the second surface 17 is not limited thereto. That is, the second surface 17 may be tilted relative to the optical axis X. In this case, a tilt angle of the second surface 17 relative to the optical axis X may vary according to a location in the diffractive surface 13. For example, the tilt angle of the second surface 17 may be larger in the central region A than in the outer region B. Also, the second surface 17 may be configured not so that the tilt angle of the second surface 17 gradually varies according to a distance in the radial direction or the height of the raised portions 15a, but so that the diffractive surface 13 is divided into a plurality of regions based on the distance in the radial direction and the height of the raised portions 15a and the tilt angle of the second surface 17 is uniform in the same region and different between different regions.

As long as the extent of chamfering of the valley bottoms 15c varies according to a location in the diffractive surface 13, the extent of chamfering of the valley bottoms 15c is not limited to the above-described embodiments. For example, the extent of the chamfering of the valley bottoms 15c may be larger in the central region A than in the outer region B. Specifically, the radius of curvature of the surface 15d of the valley bottoms 15c in the central region A may be larger than that of the surface 15d of the valley bottoms 15c in the outer region B. Also, the valley bottoms 15c may be chamfered so that the extent of chamfering of the valley bottoms 15c varies gradually according to a distance from the center of the diffractive surface 13 in the radial direction or the height of the raised portions 15a, but so that the diffractive surface 13 is divided into a plurality of regions based on the distance in the radial direction or the height of the raised portions 15a and the extent of chamfering of the valley bottoms 15c is uniform in the same region and different between different regions.

The extent of chamfering of the valley bottoms 15c preferably set to be larger in a region in which cracks at the valley bottoms 15c occurs more likely. Cracks at the valley bottoms 15c occur more likely in the outer side in the radial direction in a cooling step of press molding. Moreover, the larger the depth of the recessed portions 15b is, or the larger the aspect ratio (the ratio of the depth to the width) of the recessed portions 15b is, cracks at the valley bottoms 15c occur more likely. That is, the valley bottoms 15c may be configured so that the extent of chamfering of the valley bottoms 15c increases as a distance from the center of the diffractive optical element increases. The valley bottoms 15c may be configured so that the extent of chamfering of the valley bottoms 15c increases as the depth of the surface 15d increases. The valley bottoms 15c may be configured so that the extent of chamfering of the valley bottoms 15c increases as the aspect ratio of the recessed portions 15b increases.

Other than what is described above, there are other factors to cause cracks at the valley bottoms 15c, and there are cases where cracks likely occur in the inner side in the radial direction depending on conditions of molding. In such a case, the valley bottoms 15c may be formed so that the extent of chamfering of the valley bottoms 15c increases as a distance to the center in the radial direction reduces.

The chamfered shape of the valley bottoms 15c is not limited to the above-described embodiments. As long as the connection portion of two surfaces (the first surface 16 and the second surface 17) forming the recessed portion 15b is formed not by a valley line but by a surface, the connection portion may have any shape. That is, each of the valley bottoms 15c may be formed of a flat surface, a curved surface, or a combination of the flat and curved surfaces. Also, the curved shape is not limited to one having a cross section with an exact arch shape.

Furthermore, each of the raised portions 15a has a triangular lateral cross-sectional shape, but is not limited thereto. In the lateral cross-section, the first surface 16 and the second surface 17 are represented by straight lines, but may have a shape formed by curved lines.

The raised portions 15a may be formed so that each of the raised portions 15a has a rectangular lateral cross-sectional shape or a step like cross-sectional shape. In that case, each of the raised portions 15a has a surface extending substantially perpendicular to the optical axis X and surfaces each rising from the base surface substantially in the optical axis X direction. Each of the former surfaces serves as the first surface 16 having the diffractive function, and each of the latter surfaces serves as the second surface 17 rising from the base surface. In this case, the bottom of each of the recessed portions is formed by a surface (which will be hereinafter referred to as a “bottom surface”) extending substantially perpendicular to the optical axis X. Each of the second surfaces 17 is connected to an associated one of both ends of the bottom surface, and each connection portion is normally a valley line. In such a configuration, the connection portion of the bottom surface and each of the second surfaces 17, which is normally formed as a valley line, corresponds to the valley bottom of the recessed portion. The valley bottom formed by the connection portion of the bottom surface of each of the second surfaces 17 is formed to have the chamfered shape.

Also, the base surface 19 on which the raised portions 15a are formed is a flat surface, but is not limited thereto. For example, the base surface 19 may be curved to be raised or depressed.

In the above-described embodiments, assuming that the diffractive surface 13 is divided into two regions in the radial direction, one of the two regions which is located closer to the center of the diffractive surface 13 is referred to as the central region A, and the other of the two regions which is located at the outer side of the diffractive surface 13 is referred to as the outer region B. However, the present invention is not limited thereto. The central region A may be any region as long as it is a part of the diffractive surface 13 and includes the optical axis X. The outer region B may be any region as long as it is a region located outside the central region A in the radial direction, and does not have to be necessarily in contact with the central region A.

The present disclosure is not limited to the above embodiments, and may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes and modifications which come within the meaning and range of equivalency of the claims are to be embraced within their scope.

The present disclosure is useful for a diffractive optical element including a diffractive surface and an imaging apparatus including the diffractive optical element.

What is claimed is:

1. A diffractive optical element, comprising
a diffractive surface,
wherein
raised portions and recessed portions are alternately arranged on the diffractive surface, and
a shape of valley bottoms of the recessed portions varies according to regions of the diffractive surface.

2. The diffractive optical element of claim 1, wherein
the shape of the valley bottoms of the recessed portions in a central region of the diffractive surface is different from that in an outer region located outside the central region.

3. The diffractive optical element of claim 2, wherein
each of the valley portions of the recessed portions is formed to have a chamfered shape, and
an extent of chamfering of the valley portions in the outer region is larger than that in the central region.

4. The diffractive optical element of claim 2, wherein
each of the valley portions of the recessed portions is formed to have a chamfered shape, and
an extent of chamfering of the valley portions in the central region is larger than that in the outer region.

5. The diffractive optical element of claim 1, wherein
a depth of the recessed portions varies according to regions in the diffractive surface, and
the shape of the valley portions in a region in which the depth of the recessed portions is large is different from that in a region in which the depth of the recessed portions is small.

6. The diffractive optical element of claim 5, wherein
each of the valley portions of the recessed portions is formed to have a chamfered shape, and
an extent of chamfering of the valley portions in the region in which the depth of the recessed portions is large is larger than that in the region in which the depth of the recessed portions is small.

7. An imaging apparatus, comprising:
the diffractive optical element of claim 1.
